(19) United States
(12) Patent Application Publication
(10) Pub. No.: US 2026/0353051 A1
(43) Pub. Date: Nov. 5, 2026

(54) VEHICLE SAFETY RATING APPLICATION HANDOVER BETWEEN NETWORK DEVICES

(71) Applicant: QUALCOMM Incorporated, San Diego, CA (US)

(72) Inventors: Guangyi LIU, Shanghai (CN); Gabi SARKIS, San Diego, CA (US); Hui GUO, Beijing (CN)

(21) Appl. No.: 19/486,889

(22) PCT Filed: Aug. 4, 2023
(86) PCT No.: PCT/CN2023/111156

§ 371 Date: Nov. 21, 2025

(51) Int. Cl. H04W 4/40; H04W 36/00; H04W 36/30

(52) U.S. Cl. CPC H04W 4/40; H04W 36/008357; H04W 36/037; H04W 36/304

(57) ABSTRACT

An apparatus, method and computer-readable media are disclosed for performing wireless communications. For example, a first network device can transmit, to one or more network devices, a handover message for handing over communication coverage for a vehicle by the first network device to a second network device of the one or more network devices. The handover message includes one or more safety ratings required for the vehicle. The first network device can receive, from at least one of the one or more network devices, at least one response message sent in response to the handover message.

### FIELD

The present disclosure generally relates to wireless communications. For example, aspects of the present disclosure relate to systems and techniques for providing safety rating (e.g., automotive safety integrity level (ASIL)) application handover between network devices (e.g., between base stations (BSs)).

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others. A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users.

Aspects of wireless communication may comprise direct communication between devices, such as vehicle-to-everything (V2X), vehicle-to-network (V2N), vehicle-to-vehicle (V2V), and/or device-to-device (D2D) communication. In some cases, a network device, such as a base station (e.g., a 5G NR base station) that is providing communication coverage to a vehicle may handover communication coverage for the vehicle from the network device to another nearby network device. For example, the network device can use signaling (e.g., wireless communication, such as V2X) between the network device and the vehicle, and between the network device and the other network device, to perform the handover procedure.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. According to at least one illustrative example, a first network device for wireless communication is provided. The first network device includes at least one memory and at least one processor coupled to the at least one memory and configured to: transmit, via at least one transceiver to one or more network devices, a handover message for handing over communication coverage for a vehicle by the first network device to a second network device of the one or more network devices, wherein the handover message comprises one or more safety ratings required for the vehicle; and receive, via the at least one transceiver from at least one of the one or more network devices, at least one response message sent in response to the handover message.

In another illustrative example, a method of wireless communication performed at a first network device is provided. The method includes: transmitting, to one or more network devices, a handover message for handing over communication coverage for a vehicle by the first network device to a second network device of the one or more network devices, wherein the handover message comprises one or more safety ratings required for the vehicle; and receiving, from at least one of the one or more network devices, at least one response message sent in response to the handover message.

In another illustrative example, a non-transitory computer-readable storage medium of a first network device is provided that includes instructions stored thereon which, when executed by at least one processor, causes the at least one processor to: transmit, via at least one transceiver to one or more network devices, a handover message for handing over communication coverage for a vehicle by the first network device to a second network device of the one or more network devices, wherein the handover message comprises one or more safety ratings required for the vehicle; and receive, via the at least one transceiver from at least one of the one or more network devices, at least one response message sent in response to the handover message.

In another illustrative example, an apparatus for wireless communication is provided. The apparatus includes: means for transmitting, to one or more network devices, a handover message for handing over communication coverage for a vehicle by the first network device to a second network device of the one or more network devices, wherein the handover message comprises one or more safety ratings required for the vehicle; and means for receiving, from at least one of the one or more network devices, at least one response message sent in response to the handover message.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a diagram illustrating an example of a system for an ASIL application handover between network devices, where there is only one second network device, in accordance with some examples;

FIG. 6 is a diagram illustrating an example of a system for an ASIL application handover between network devices, where there are multiple second network devices, in accordance with some examples;

FIG. 7 is a diagram illustrating an example of a system for an ASIL application handover between network devices, where there are a second network device and a third network device, in accordance with some examples;

FIG. 8 is a flow diagram illustrating an example process for wireless communication, in accordance with aspects of the present disclosure; and

FIG. 9 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless communication systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”) , according to the Next Generation Mobile Networks Alliance, is designed to provide data rates of several tens of megabits per second to each of tens of thousands of users.

Vehicles are an example of systems that can include wireless communications capabilities. For example, vehicles (e.g., automotive vehicles, autonomous vehicles, semi-autonomous vehicles, aircraft, maritime vessels, among others) can communicate with other vehicles and/or with other devices, such as base stations, that have wireless communications capabilities. Wireless vehicle communication systems encompass vehicle-to-vehicle (V2V), vehicle-to-infrastructure (V2I), vehicle-to-network (V2N), and vehicle-to-pedestrian (V2P) communications, vehicle-to-grid (V2G) communications (e.g., data going to the electric grid, such as for the purpose of actively managing energy in electric vehicles or other electric devices or systems), which are all collectively referred to as vehicle-to-everything (V2X) communications. V2X communications is a vehicular communication system that supports the wireless transfer of information from a vehicle to other entities (e.g., base stations, other vehicles, pedestrians with smart phones, equipped vulnerable road users (VRUs), such as bicyclists, roadside units (RSUs) and/or other traffic infrastructure) located within the traffic system that may affect and/or assist the vehicle. The main purpose of the V2X technology is to improve road safety, fuel savings, and traffic efficiency.

Vehicles may be required to adhere to certain safety ratings. For example, the International Organization of Standardization (ISO) defines automotive safety integrity levels (ASILs), and provides some associated reliability values that a system, component, and/or item of a vehicle needs to meet to achieve a specific ASIL rating. ASIL is a risk classification system defined by the ISO 26262 standard for the functional safety of road vehicles. The standard defines functional safety as “the absence of unreasonable risk due to hazards caused by malfunctioning behavior of electrical or electronic systems.” ASILs establish safety requirements, based on the probability and acceptability of harm, for automotive components to be compliant with ISO 26262.

There are four grades of ASILs identified by ISO 26262, including A grade, B grade, C grade, and D grade. An ASIL A grade represents the lowest degree of automotive hazard, and an ASIL D grade represents the highest degree of automotive hazard. For example, systems such as airbags, anti-lock brakes, and power steering require an ASIL-D grade, the highest rigor applied to safety assurance, because of the high risks associated with their failure. On the other end of the safety spectrum, components such as rear lights only require an ASIL-Agrade. Head lights and brake lights generally require an ASIL-B grade, while cruise control generally requires an ASIL-C grade.

Modules and/or components within a vehicle that use wired and/or wireless communication links also have ASILs that are defined. The ASIL of a wired communication link within a vehicle is typically fixed since the communications channel does not change significantly and the link can be designed to accommodate any changes. A wired communication link is a closed system that is resilient to external interference. Wireless communication links within a vehicle have a varying reliability because the links experience a variable environment and external interference. Similarly, the reliability of wireless communications between a vehicle and another entity (e.g., a network device, a base station, another vehicle, or an RSU) depend on the environment, network coverage, and network congestion. The use of autonomous driving within a vehicle requires a reliable connection between the vehicle and the network (e.g., via a network device, such as a base station).

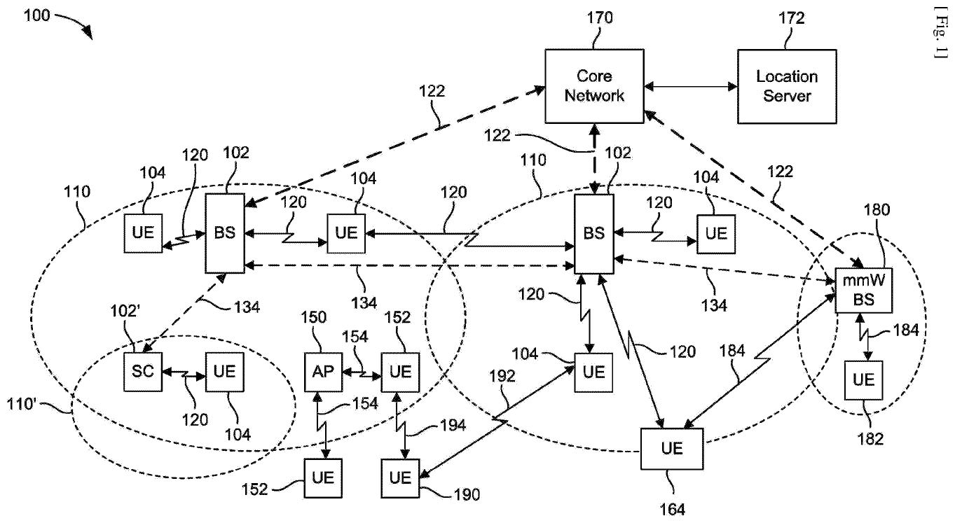

For automobile applications, such as autonomous driving applications, that require an ASIL rating for their associated wireless networks, wireless communication signaling between a network device (e.g., a base station) and a vehicle and/or between the network device and a cloud (e.g., a cloud server) should be designed to ensure seamless service for the application. For example, when a vehicle, such as an autonomous vehicle, is located within a communication coverage area provided by a network device (e.g., a base station), the network device may provide communication coverage to the vehicle (e.g., for performing of an automobile application, such as an autonomous driving application). A communication coverage area can include a geographic coverage area for which a network device (e.g., a base station) provides communication coverage (e.g., use of one or more communication resources for reception and/or transmission of information) for one or more communication devices, such as one or more UEs (e.g., vehicles). In some cases, a communication coverage area can be referred to as a “cell.” For instance, as described herein (e.g., with respect to FIG. 1), a cell can include a geographic coverage area of a base station in which a carrier frequency may be detected and used for communication by a communication device (e.g., a UE) within the geographic coverage area (e.g., geographic coverage areas 110 of FIG. 1).

As the vehicle is leaving the coverage area of the network device, the network device will need to handover the communication coverage for the vehicle to another nearby network device that is located in an area that the vehicle is headed. The network device can use signaling (e.g., wireless communication, such as V2X) between the network device and the vehicle, and between the network device and the other network device to perform the handover procedure. The network device will select the other network device to handover the communication coverage for the vehicle based on whether the other network device is able to maintain the required ASIL ratings. A technique for handing over communication coverage for a vehicle from a network device (e.g., a first base station) to another network device (e.g., a second base station) while maintaining a required ASIL rating for the associated wireless networks can be beneficial.

In one or more aspects of the present disclosure, systems, apparatuses, methods (also referred to as processes), and computer-readable media (collectively referred to herein as “systems and techniques”) are described herein that provide solutions for providing a safety rating (e.g., ASIL) application handover between network devices. In one or more aspects, the systems and techniques provide solutions for ASIL application handovers between base stations, such as between a first base station and a second base station.

In one or more aspects, for a handover of communication coverage of a vehicle from a first base station to a second base station, a vehicle can send a handover message to the first base station (which can forward the message to the second base station) or to the second base station. The handover message can be used by the first base station to perform a handover of communication coverage for the vehicle to another base station (e.g., to the second base station or other base station). In one or more examples, the handover message may include, but is not limited to, the required ASIL rating (e.g., A grade, B grade, C grade, or D grade); configuration parameters of the vehicle (e.g., related to communication, such as number of antennas, location of antennas represented by a certain index, year of the vehicle, make of the vehicle, etc.); the required rate, latency, and reliability of the applications of the vehicle related to ASIL; the route of the vehicle; and/or the destination of the vehicle.

In one or more examples, the second base station can use a handover message including the information previously described to compute whether the required ASIL rating can be satisfied by the second base station and/or to calculate the best ASIL rating that the second base station can achieve. For example, the second base station can compute the required communication resources (e.g., number of resource blocks) needed to satisfy the ASIL rating. The use of the information allows the second base station to readily determine whether the second base station can satisfy the ASIL rating or determine the best ASIL that the second base station can achieve. This determination can be beneficial for situations when there are multiple available candidate base stations for the handover.

In one or more aspects, when there are multiple base stations (e.g., multiple second base stations) available for the handover of communication coverage of a vehicle, a first base station can send an inquiry message to the multiple base stations to check if the required ASIL rating can be satisfied by any of the base stations. In one or more examples, each of the multiple base stations can send to the first base station one bit indicating whether the required ASIL rating can be achieved by the base station; an indication of the best ASIL rating that can be achieved; and/or the achievable rate, latency, or reliability. In some cases, each of the multiple base stations can also send an indication of how far (e.g., the distance) the base station can provide coverage. The first base station can then choose one “qualified” base station from the multiple base stations to perform the handover. This handover procedure provides a solution for determining the proper base station for handover of communication coverage of a vehicle, when there are multiple candidate base stations (e.g., multiple second base stations) available for the handover.

In one or more examples, when the first base station determines that there are no “qualified” base stations for the handover, a task (e.g., a task to process one or more communication signals) can be split among multiple base stations (e.g., multiple second base stations), where each base station can undertake part of the communication load and the processing task. For example, if the vehicle has six cameras capturing video, two second base stations each can process video from three of the cameras. Each base station of the multiple base stations can send, to the first base station, the maximum traffic load in order to achieve a certain ASIL rating. The first base station can select which of the base stations the vehicle will be handed over to and will send signaling to inform the vehicle of the chosen base station(s). This handover procedure provides a solution when there are no “qualified” base stations for the handover, in which case multiple base stations can share the communication/processing load.

In one or more aspects, a deep base station search (e.g., for a second base station, a third base station, a fourth base station, etc.) can be performed by the first base station to determine, for the handover of communication coverage for the vehicle, qualified base stations that are located further along a route of the vehicle. This deep base station search procedure can allow for handovers to multiple base stations located along a particular route of a vehicle.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR 1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”) . In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or fewer carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y, ’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

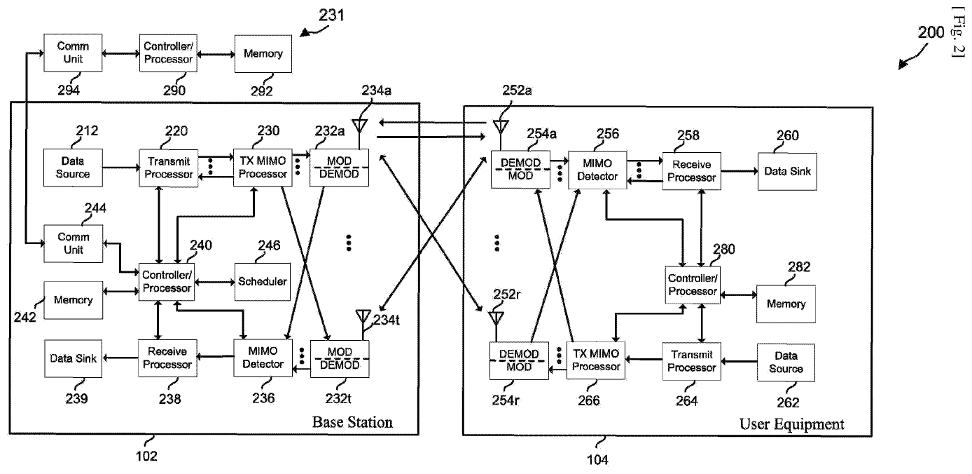

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

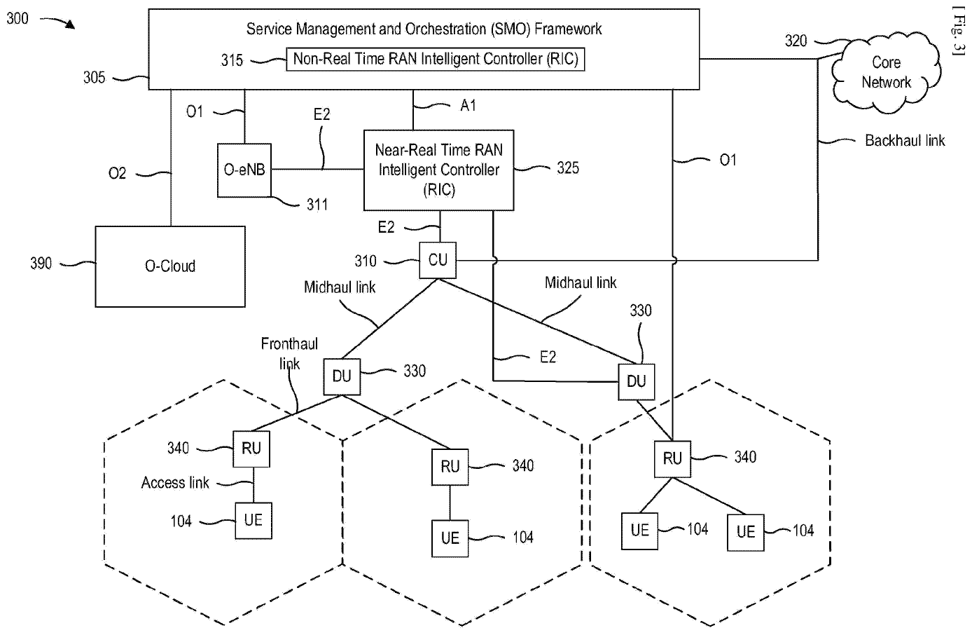

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

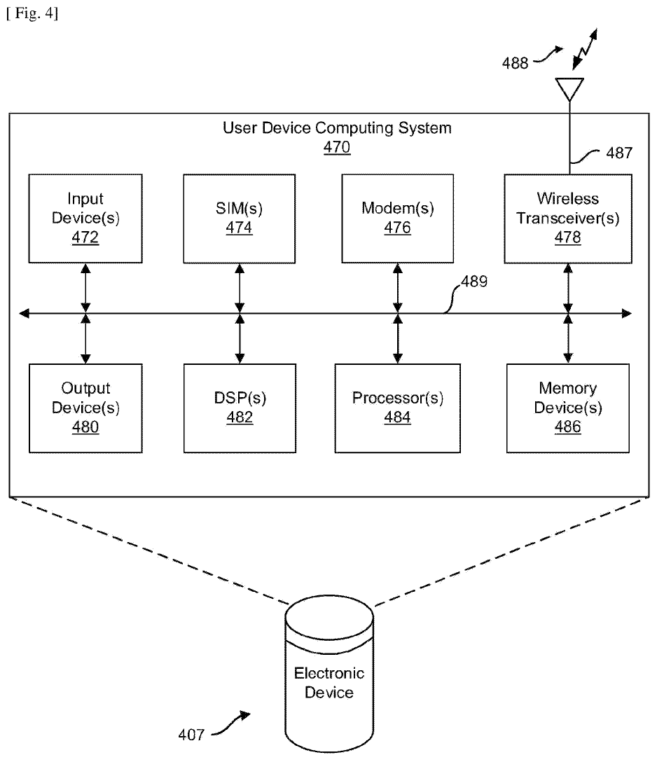

FIG. 4 is a block diagram illustrating an example of a computing system 470 of an electronic device 407, which may be employed by the disclosed systems and techniques for utilizing UE for measurement fusion in multi-target sensing. The electronic device 407 is an example of a device that can include hardware and software for the purpose of connecting and exchanging data with other devices and systems using a communications network (e.g., a 3rd Generation Partnership network, such as a 5th Generation (5G)/New Radio (NR) network, a 4th Generation (4G)/Long Term Evolution (LTE) network, a WiFi network, or other communications network). For example, the electronic device 407 can include, or be a part of, a network device, such as a base station (e.g., a 3GPP gNB for 5G/NR, a 3GPP eNB for LTE, a Wi-Fi AP, or other base station) or a component of a base station, a component of a disaggregated base station (e.g., a central unit, a distributed unit, and/or a radio unit), a vehicle or component of a vehicle, a mobile device (e.g., a mobile telephone), a wearable device (e.g., a network-connected or smart watch), an extended reality device (e.g., a virtual reality (VR) device, an augmented reality (AR) device, or a mixed reality (MR) device), a personal computer, a laptop computer, a tablet computer, an Internet-of-Things (IoT) device, a wireless access point, a router, a server computer, a robotics device, and/or other device used by a user to communicate over a wireless communications network. In some cases, the device 407 can be referred to as user equipment (UE), such as when referring to a device configured to communicate using 5G/NR, 4G/LTE, or other telecommunication standard. In some cases, the device can be referred to as a station (STA), such as when referring to a device configured to communicate using the Wi-Fi standard.

The computing system 470 includes software and hardware components that can be electrically or communicatively coupled via a bus 489 (or may otherwise be in communication, as appropriate). For example, the computing system 470 includes one or more processors 484. The one or more processors 484 can include one or more CPUs, ASICs, FPGAs, APs, GPUs, VPUs, NSPs, microcontrollers, dedicated hardware, any combination thereof, and/or other processing device/sand/or system/s. The bus 489 can be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone or a microphone array, and/or the like), and one or more output devices 480 (e.g., a display, a speaker, a printer, and/or the like).

The one or more wireless transceivers 478 can receive wireless signals (e.g., signal 488) via antenna 487 from one or more other devices, such as other user devices, network devices (e.g., base stations such as evolved Node Bs (eNBs) and/or gNodeBs (gNBs), WiFi access points (APs) such as routers, range extenders or the like, etc.), cloud networks, and/or the like. In some examples, the computing system 470 can include multiple antennas or an antenna array that can facilitate simultaneous transmit and receive functionality. Antenna 487 can be an omnidirectional antenna such that RF signals can be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 488 into a baseband or intermediate frequency and can convert the RF signals to the digital domain.

In some cases, the computing system 470 can include a coding-decoding device (or CODEC) configured to encode and/or decode data transmitted and/or received using the one or more wireless transceivers 478. In some cases, the computing system 470 can include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 478.

The one or more SIMs 474 can each securely store an international mobile subscriber identity (IMSI) number and related key assigned to the user of the electronic device 407. The IMSI and key can be used to identify and authenticate the subscriber when accessing a network provided by a network service provider or operator associated with the one or more SIMs 474. The one or more modems 476 can modulate one or more signals to encode information for transmission using the one or more wireless transceivers 478. The one or more modems 476 can also demodulate signals received by the one or more wireless transceivers 478 in order to decode the transmitted information. In some examples, the one or more modems 476 can include a WiFi modem, a 4G (or LTE) modem, a 5G (or NR) modem, and/or other types of modems. The one or more modems 476 and the one or more wireless transceivers 478 can be used for communicating data for the one or more SIMs 474.

The computing system 470 can also include (and/or be in communication with) one or more non-transitory machine-readable storage media or storage devices (e.g., one or more memory devices 486), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 can also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

In some aspects, the electronic device 407 can include means for performing operations described herein. The means can include one or more of the components of the computing system 470. For example, the means for performing operations described herein may include one or more of input device(s) 472, SIM(s) 474, modems(s) 476, wireless transceiver(s) 478, output device(s) 480, DSP(s) 482, processors 484, memory device(s) 486, and/or antenna(s) 487.

In some aspects, the electronic device 407 can include means for providing joint communications and sensing as well as a means for utilizing UE for measurement fusion in multi-target sensing, for example, when multiplexing sensing and communication signals for joint communications and sensing (JCS). In some examples, any or all of these means can include the one or more wireless transceivers 478, the one or more modems 476, the one or more processors 484, the one or more DSPs 482, the one or more memory devices 486, any combination thereof, or other component(s) of the electronic device 407.

As previously mentioned, ISO defines ASILs, and provides some associated reliability values that a system, component, and/or item of a vehicle needs to meet to achieve a specific ASIL rating. The four grades of ASILs identified by ISO 26262 include A grade, B grade, C grade, and D grade, where the A grade represents the lowest degree of automotive hazard (e.g., encompassing components such as rear lights) and the D grade represents the highest degree of automotive hazard (e.g., representing components such as airbags, anti-lock brakes, power steering, etc.).

Modules and/or components within a vehicle that use wired and/or wireless communication links also have ASILs that are defined by ISO 26262. The ASIL of a wired communication link within a vehicle is generally fixed because the communications channel does not change significantly, and the link can be designed to accommodate any changes. A wired communication link is a closed system that is resilient to external interference. Wireless communication links within a vehicle have a varying reliability because the links experience a variable environment and external interference. Similarly, the reliability of wireless communications between a vehicle and another entity (e.g., a network device, a base station, another vehicle, or an RSU) depend on the environment, network coverage, and network congestion. The use of autonomous driving within a vehicle requires a reliable connection between the vehicle and the network (e.g., via a network device, such as a base station).

For automobile applications, such as autonomous driving applications, that require an ASIL rating for their associated wireless networks, wireless communication signaling between a network device (e.g., a base station) and a vehicle and/or between the network device and a cloud (e.g., a cloud server) should be designed to guarantee seamless service for the application. In one or more examples, when a vehicle (e.g., an autonomous vehicle) is located within a communication coverage area of a network device (e.g., a base station), the network device may provide communication coverage to the vehicle (e.g., for performing of an automobile application, such as an autonomous driving application). As the vehicle is leaving the coverage area of the network device, the network device (e.g., a first base station) will need to handover the communication coverage for the vehicle to another nearby network device (e.g., a second base station) that is located in an area that the vehicle is headed. The network device (e.g., the first base station) can use signaling (e.g., wireless communication, such as V2X) between the network device (e.g., the first base station) and the vehicle, and between the network device (e.g., the first base station) and the other network device (e.g., the second base station) to perform the handover procedure. The network device (e.g., the first base station) will select the other network device (e.g., second base station) to handover the communication coverage for the vehicle based on whether the other network device (e.g., second base station) is able to maintain the required ASIL ratings. A technique for handing over communication coverage for a vehicle from a network device (e.g., a first base station) to another network device (e.g., a second base station) while maintaining a required ASIL rating for the associated wireless networks can be beneficial.

In some cases, the systems and techniques provide solutions for providing an ASIL application handover between network devices. In one or more aspects, the systems and techniques provide solutions for ASIL application handovers between base stations, such as between a first base station and a second base station.

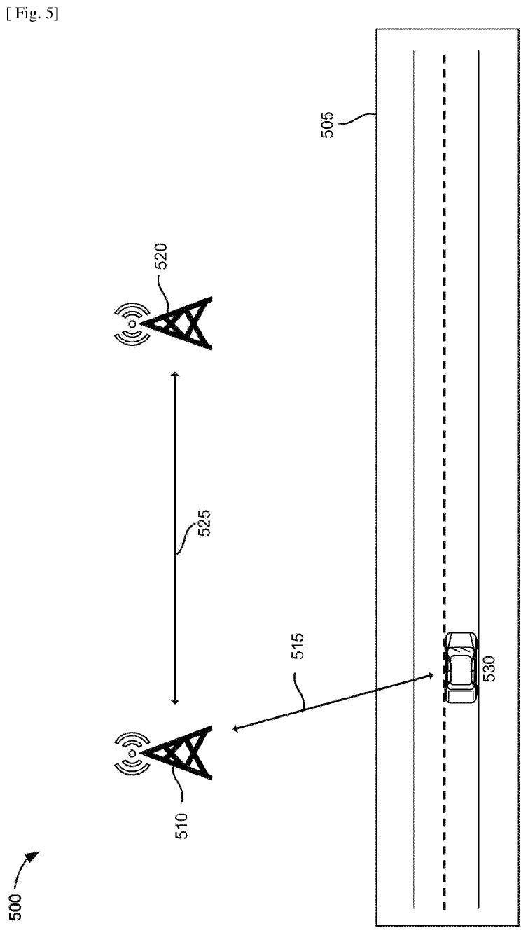

In one or more aspects, FIG. 5 shows an example for a handover of communication coverage of a vehicle from a first network device to a second network device. In particular, FIG. 5 is a diagram illustrating an example of a system 500 for an ASIL application handover between network devices, where there is only one second network device. In the system 500 of FIG. 5, a first network device 510 (e.g., a first base station, such as in the form of a gNB), a second network device 520 (e.g., a second base station, such as in the form of a gNB), and a vehicle 530 (e.g., an autonomous vehicle) are shown. In one or more examples, the system 500 of FIG. 5 may have more or less number of first network devices 510, second network devices 520, and/or vehicles 530, than as shown in FIG. 5. In FIG. 5, the vehicle 530 is shown to be driving along a road 505, in a direction from left to right across the figure.

In the system 500 of FIG. 5, the vehicle 530 is wirelessly communicatively coupled to the first network device 510 (e.g., first base station) as shown by wireless link 515, and the first network device 510 (e.g., first base station) is communicatively coupled (e.g., via wire and/or wirelessly) with the second network device 520 (e.g., second base station) as shown by link 525. In FIG. 5, the vehicle 530 is within a coverage area of the first network device 510 (e.g., first base station), and first the network device 510 (e.g., first base station) is providing communication coverage to the vehicle 530 while maintaining a wireless connection with a certain ASIL rating.

In one or more examples, for a handover of communication coverage for the vehicle 530 from the first network device 510 (e.g., first base station) to the second network device 520 (e.g., second base station), while maintaining a wireless connection with the certain ASIL rating, the first network device 510 can send (e.g., transmit via a unicast) a handover message to the second network device 520 via the link 525. In one or more examples, the handover message can include one or more safety ratings required for the vehicle 530 (e.g., for wireless communication with the vehicle 530). Each of the safety ratings may be an ASIL rating, such as with an A grade, a B grade, a C grade, or a D grade.

In some examples, the handover message can further include one or more parameters. The parameters can include, but are not limited to, one or more communication configuration parameters of the vehicle 530, a required data rate for one or more applications of the vehicle 530 that are related to the one or more safety ratings, a required latency for the one or more applications, a required reliability for the one or more applications, a route of the vehicle 530, and/or a destination of the vehicle 530. In some aspects, a required data rate for an application related to an ASIL rating can indicate the minimum required data rate when using that application. In some cases, a required latency for an application related to an ASIL rating can indicate the maximum communication latency of a communication link between the vehicle 530 and a particular network device that is allowed when using that application. In some examples, a required reliability for an application related to an ASIL rating can indicate the minimum required reliability of a communication link between the vehicle 530 and a particular network device (e.g., based on network conditions, such as network coverage and/or network congestion, etc.) when using that application. The communication configuration parameters of the vehicle 530 can include, but are not limited to, a quantity of antennas of the vehicle 530, a location of the antennas on the vehicle 530 (e.g., which may be represented by a certain index number), a brand associated with the one or more antennas, a type of the one or more antennas, a model of the one or more antennas, a year of the vehicle 530, a make of the vehicle 530, any combination, thereof, and/or other parameters. In one or more examples, the route of the vehicle 530 can be represented by a certain code (e.g., a route code), by one or more indexes (e.g., road segment identifiers (IDs)), and/or other representation. In some examples, the destination of the vehicle 530 may be represented by a certain code (e.g., a destination code).

In one or more examples, the handover message may be an X-3 message or a different type of message. In some examples, when the handover message is implemented within an X-3 message, additional fields may be added within an existing X-3 message for the safety ratings and the parameters of the handover message.

In one or more examples, the second network device 520 can use the received safety ratings and parameters of the vehicle 530 to determine (e.g., compute) whether the required ASIL rating can be satisfied by the second network device 520 when providing communication coverage to the vehicle 530, or to determine (e.g., compute) the best ASIL rating that the second network device 520 can achieve when providing communication coverage to the vehicle 530. In one or more examples, the second network device 520 can determine the best ASIL rating that the second network device 520 can achieve taking into consideration additional factors related to the vehicle 530 including, but not limited to, the operation of the vehicle 530 (e.g., teleoperated driving of the vehicle 530 and/or advanced driving of the vehicle 530), a quality of service (QoS) for wireless communication for the vehicle 530, and/or wireless communication metrics for the wireless communication for the vehicle 530 (e.g., the percentage of wireless communication errors that can be detected or corrected). In one or more examples, the second network device 520 can determine the best ASIL rating that the second network device 520 can achieve taking into consideration additional factors related to the second network device 520 such as the communication quality of itself. The second network device 520 is aware of its communication quality along the route of the vehicle 530 (e.g., along the road 505). In some examples, the second network device 520 can use the safety ratings and parameters of the vehicle 530 to determine (e.g., compute) the communication resources, such as the number of resource blocks (RBs), required to satisfy the required ASIL ratings.

In one or more examples, the second network device 520 can send (e.g., transmit via link 525) a response message to the first network device 520 in response to the handover message. In some examples, the response message can include a confirmation from the second network device 520 to accept handover of communication coverage for the vehicle 530 from the first network device 520. The first network device 520 can then receive the response message from the second network device 520.

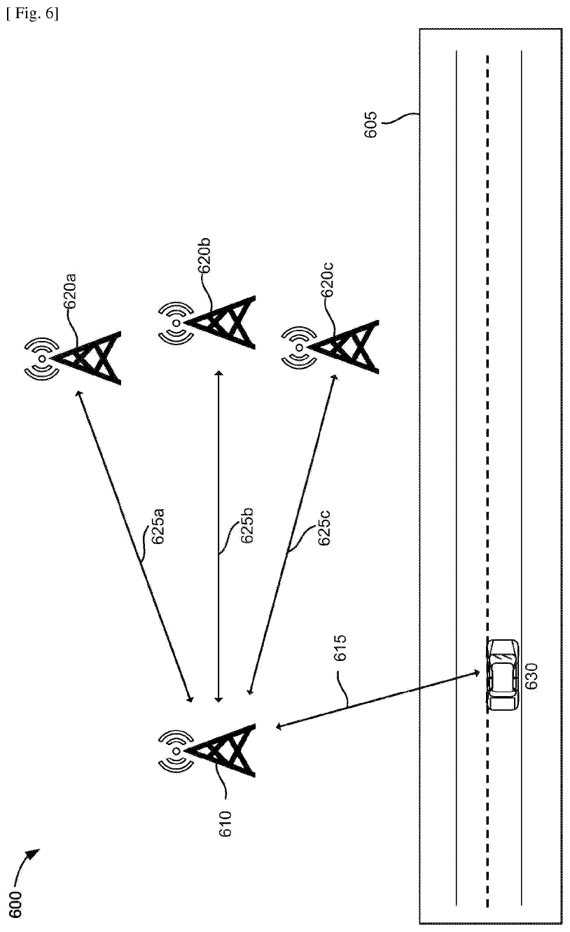

In one or more aspects, FIG. 6 shows an example for a handover of communication coverage of a vehicle from a first network device to a second network device, from a plurality of second network devices. In particular, FIG. 6 is a diagram illustrating an example of a system 600 for an ASIL application handover between network devices, where there are multiple second network devices. In the system 600 of FIG. 6, a first network device 610 (e.g., a first base station, such as in the form of a gNB), multiple second network devices 620a, 620b, 620c (e.g., each a second base station, such as in the form of a gNB), and a vehicle 630 (e.g., an autonomous vehicle) are shown. In one or more examples, the system 600 of FIG. 6 may have more or less number of first network devices 610, second network devices 620, and/or vehicles 630, than as shown in FIG. 6. The vehicle 630 is shown in FIG. 6 to be driving along a road 605, in a direction from left to right across the figure.

In the system 600 of FIG. 6, the vehicle 630 is wirelessly communicatively coupled to the first network device 610 (e.g., first base station) as shown by wireless link 615, the first network device 610 (e.g., first base station) is communicatively coupled (e.g., via wire and/or wirelessly) with the second network device 620a (e.g., a second base station) as shown by link 625a, the first network device 610 (e.g., first base station) is communicatively coupled (e.g., via wire and/or wirelessly) with the second network device 620b (e.g., a second base station) as shown by link 625b, and the first network device 610 (e.g., first base station) is communicatively coupled (e.g., via wire and/or wirelessly) with the second network device 620c (e.g., a second base station) as shown by link 625c. In FIG. 5, the vehicle is 630 within a coverage area of the first network device 610 (e.g., first base station). In FIG. 5, the first the network device 610 (e.g., first base station) is providing communication coverage to the vehicle 630 while maintaining a wireless connection with a certain ASIL rating.

In one or more examples, for a handover of communication coverage for the vehicle 630 from the first network device 610 (e.g., first base station) to one of the second network devices 620a, 620b, 620c (e.g., a second base station), while maintaining a wireless connection with the certain ASIL rating, the first network device 610 can send (e.g., transmit via a broadcast) a handover message (e.g., an inquiry message) to the second network devices 620a, 620b, 620c via the links 625, 625b, 625c, respectively. In one or more examples, the handover message can include one or more safety ratings required for the vehicle 630 (e.g., for wireless communication with the vehicle 630). Each safety rating can be an ASIL rating (e.g., with an A grade, a B grade, a C grade, or a D grade). In some examples, the handover message can further include one or more parameters (e.g., including the parameters described in the description of FIG. 5).

In one or more examples, each of the second network devices 620a, 620b, 620c can use the received safety ratings and parameters of the vehicle 630 to determine (e.g., compute) whether the required ASIL rating can be satisfied by itself when providing communication coverage to the vehicle 630, or to determine (e.g., compute) the best ASIL rating that it can achieve when providing communication coverage to the vehicle 630. In one or more examples, each second network device 620a, 620b, 620c can determine the best ASIL rating that it can achieve taking into consideration additional factors related to the vehicle 630, which may include, but is not limited to, the operation of the vehicle 630 (e.g., teleoperated driving of the vehicle 630 and/or advanced driving of the vehicle 630), a QoS for wireless communication for the vehicle 630, and/or wireless communication metrics for the wireless communication for the vehicle 630 (e.g., the percentage of wireless communication errors that can be detected or corrected). In one or more examples, each second network device 620a, 620b, 620c can determine the best ASIL rating that it can achieve taking into consideration additional factors related to itself such as the communication quality of itself. Each second network device 620a, 620b, 620c is aware of its communication quality along the route of the vehicle 630 (e.g., along the road 605). In some examples, each second network device 620a, 620b, 620c can use the safety ratings and parameters of the vehicle 630 to determine (e.g., compute) the communication resources (e.g., number of RBs) required to satisfy the required ASIL ratings.

In one or more examples, one or more of the second network devices 620a, 620b, 620c can each send (e.g., transmit via link 625a, 625b, 625c, respectively) a response message to the first network device 620 in response to the handover message. In some examples, the response message can include a capability (e.g., capability information) of the second network device 620a, 620b, 620c sending the response message. In one or more examples, the capability information may include, but is not limited to, whether each of the one or more safety ratings can be achieved by the second network device 620a, 620b, 620c; a highest (e.g., best) safety rating from the one or more safety ratings that can be achieved by the second network device 620a, 620b, 620c; a maximum traffic load (e.g., an amount of traffic per unit of time, which can be represented in megabits per second (Mbits/s)), to achieve the highest safety rating from the one or more safety ratings that can be achieved by the network device 620a, 620b, 620c; a highest data rate (e.g., an average value or bottleneck value of a data rate of communication coverage provided by a particular network device) that can be achieved by the vehicle 630 for one or more applications of the vehicle 630 that are related to the one or more safety ratings; a lowest latency (e.g., an average value or bottleneck value of a latency of communication coverage provided by a particular network device) that can be achieved by the vehicle 630 for the one or more applications; a reliability (e.g., an average value or bottleneck value) that can be achieved by the vehicle 630 for the one or more applications; and/or a maximum distance (e.g., how far) for the communication coverage for the vehicle 630 that can be achieved. In one or more examples, for the capability, the response message can include one bit (e.g., a 1 or 0) to indicate whether or not each of the one or more safety ratings can be achieved by the second network device 620a, 620b, 620c.

In one or more aspects, the first network device 610, based on the capabilities of the second network devices 620a, 620b, 620c, can determine one or more “qualified” network devices from the second network devices 620a, 620b, 620c for a handover of communication coverage for the vehicle 630. The first network device 610 can determine a second network device to be a “qualified” network device when the first network device 610 determines, based on the capability of the second network device, that the second network device can satisfy the one or more safety ratings when providing communication coverage to the vehicle 630 (e.g., when the vehicle 630 is located within a coverage area of the second network device, such as along the road 605).

In one or more examples, when the first network device 610 has determined that more than one of the second network devices 620a, 620b, 620c is a “qualified” network device, the first network device 610 can choose one of the “qualified” network devices to handover communication coverage for the vehicle 630 based on a random selection, a network device that provides a best achievable data rate for one or more applications of the vehicle 630 that are related to the one or more safety ratings, network device that provides a best achievable latency for the one or more applications, network device that provides a best achievable reliability for the one or more applications, and/or network device that provides a longest distance (e.g., along a route of the vehicle) for the communication coverage for the vehicle 630 that can be achieved. As noted herein, the best achievable data rate, latency, reliability, and distance for each network device 620a, 620b, 620c can be provided as part of the capability information provided in the response message transmitted by the second network device 620a, 620b, 620c.

In some examples, when the first network device 610 has determined that none of the second network devices 620a, 620b, 620c is a “qualified” network device, the first network device 610 can choose one of the second network devices 620a, 620b, 620c to handover communication coverage for the vehicle 630 based on a best achievable safety rating for each of the one or more safety ratings of the second network devices 620a, 620b, 620c. Then first network device 610 can then send (e.g., transmit via the wireless link 615) to the vehicle 605 the best achievable safety rating for each of the one or more safety ratings of the second network devices 620a, 620b, 620c, such that the vehicle 605 can make any needed adjustments (e.g., reduce speed of the vehicle 605) to be able to meet the one or more required safety ratings.

In one or more examples, when the first network device 610 has determined that none of the second network devices 620a, 620b, 620c is a “qualified” network device, the first network device 610 can split one or more tasks (e.g., a communication load and processing task) amongst more than one of the second network devices 620a, 620b, 620c. In one or more examples, a task of the one or more tasks may include processing one or more communication signals. For example, if the vehicle 605 has six cameras capturing video, two of the second network devices 620a, 620b each can process video from three of the cameras. In one or more examples, the first network device 610 can send (e.g., transmit via the wireless link 615) to the vehicle 605 a notification message indicating the selected second network devices 620a, 620b performing the one or more tasks (e.g., that the performance of the one or more tasks is split amongst).

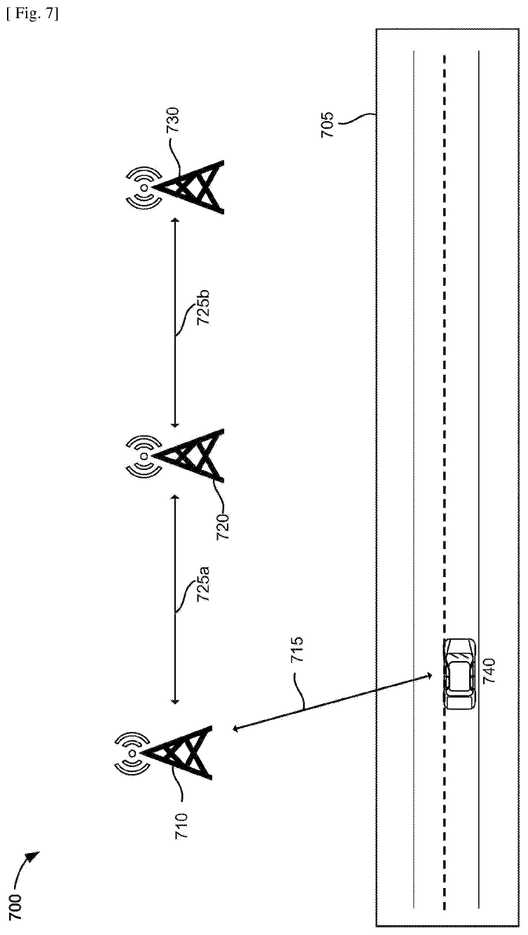

In one or more aspects, FIG. 7 shows an example for a handover of communication coverage of a vehicle, where to prevent the vehicle being routed to an area where there are no network devices (e.g., base stations) that can satisfy the one or more safety ratings while providing communication coverage to the vehicle, a first network device can perform a deep search for network devices to accept the handover. In particular, FIG. 7 is a diagram illustrating an example of a system 700 for an ASIL application handover between network devices, where there are a second network device and a third network device. In the system 700 of FIG. 7, a first network device 710 (e.g., a first base station, such as in the form of a gNB), a second network device 720 (e.g., a second base station, such as in the form of a gNB), a third network device 730 (e.g., a third base station, such as in the form of a gNB), and a vehicle 740 (e.g., an autonomous vehicle) are shown. In one or more examples, the system 700 of FIG. 7 may have more or less number of first network devices 710, second network devices 720, third network devices 730, and/or vehicles 740, than as shown in FIG. 7. In some examples, the system 700 of FIG. 7 may include more types of network devices (e.g., fourth network devices, fifth network devices, sixth network devices, etc.) than as shown in FIG. 7. In FIG. 7, the vehicle 740 is shown to be driving along a road 705, in a direction from left to right across the figure.

In the system 700 of FIG. 7, the vehicle 730 is wirelessly communicatively coupled to the first network device 710 (e.g., first base station) as shown by wireless link 715, the first network device 710 (e.g., first base station) is communicatively coupled (e.g., via wire and/or wirelessly) with the second network device 720 (e.g., a second base station) as shown by link 725a, and the second network device 720 is communicatively coupled (e.g., via wire and/or wirelessly) with the third network device 730 (e.g., a third base station) as shown by link 725b. In FIG. 7, the vehicle is 740 within a coverage area of the first network device 710 (e.g., first base station), where the first the network device 710 (e.g., first base station) is providing communication coverage to the vehicle 730 while maintaining a wireless connection with a certain ASIL rating.

In one or more examples, the first network device 710 can perform a deep base station search (e.g., for a second base station, a third base station, etc.) to determine, for the handover of communication coverage for the vehicle 740, qualified base stations that are located further along a route (e.g., along the road 705) of the vehicle 740. This deep base station search procedure can allow for handovers to multiple base stations located along a particular route of a vehicle. In one or more examples, the first network device 710 can send (e.g., transmit) a deep search handover message to the second network device 720 via the link 725a. In one or more examples, the deep search handover message can include one or more safety ratings required for the vehicle 740 (e.g., for wireless communication with the vehicle 740) and parameters for the vehicle. In some examples, the second base station 720 can send (e.g., transmit) the deep search handover message to the third network device 730 via the link 725b. The deep search handover message can be sent to subsequent network devices (e.g., base stations) located along the route (e.g., along the road 750).

The network devices (e.g., network device 2 720 and network device 3 730) along the route can send (e.g., transmit via links 725a, 725b) to the first network device 710 a response message in response to the deep search handover message. In some examples, the response message can include a capability of the network devices (e.g., network device 2 720 and network device 3 730) along the route. The first network device 710, based on the capabilities of the network devices (e.g., network device 2 720 and network device 3 730) along the route, can determine one or more “qualified” network devices from the network devices along the route for a handover of communication coverage for the vehicle 740 as the vehicle 740 travels along the route (e.g., along the road 705).

In one or more examples, the first network device 710 can send (e.g., transmit via wireless link 715) to the vehicle 740 the determined “qualified” based stations (e.g., network device 2 720 and network device 3 730) that are located along the route of the vehicle 740. In one or more examples, the first network device 710 can transmit this information to the vehicle 740 by using a downlink (DL) transmission for the vehicle 740 to make a route choice. In some examples, the first network device 710 can directly send (e.g., transmit) this information to the vehicle navigation server (e.g., a network server, such as a cloud server) for reference.

In one or more examples, based on the information, the vehicle 740 can determine one or more routes for its travel to its destination location. The vehicle 740 can report (e.g., transmit) the one or more routes to the first network device 710. In some examples, each route can be indicated by a route code, by one or more indexes (e.g., road segment identifiers (IDs)), and/or other representation. For instance, one or more route codes, for the one or more routes, can be passed (e.g., transmitted) from the first network device 710 to the other network devices (e.g., network device 2 720 and network device 3 730).

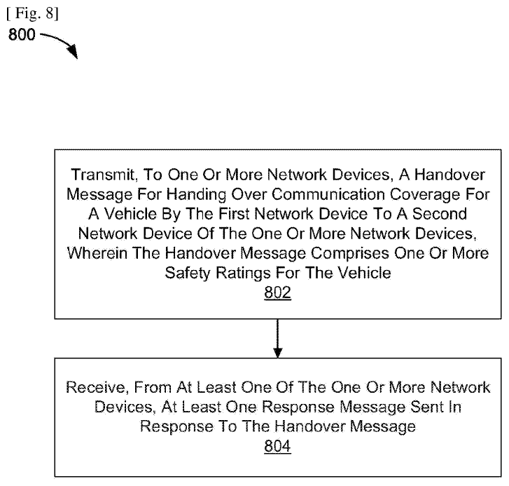

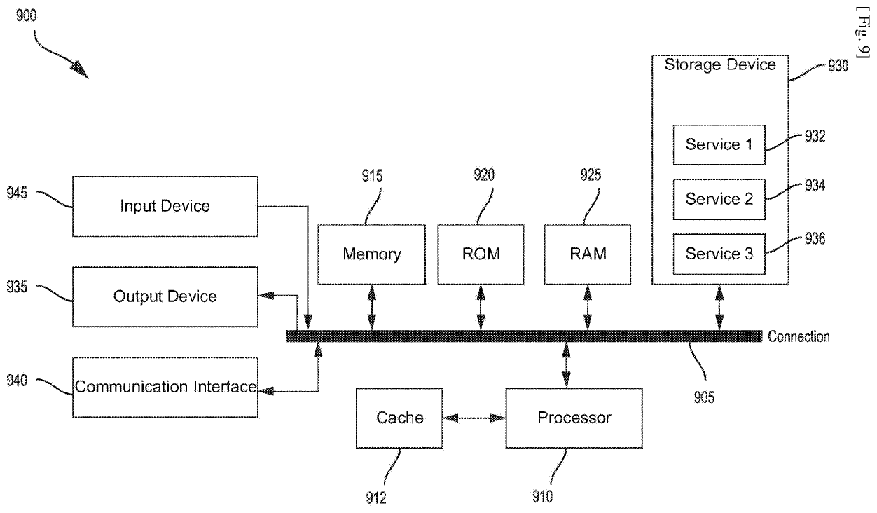

FIG. 8 is a flow diagram illustrating a process 800 for performing wireless communications. The process 800 can be performed by a component or system (e.g., a chipset) of a network device (e.g., BS 102 of FIGS. 1 and 2, electronic device 407 of FIG. 4, network device 510 of FIG. 5, network device 610 of FIG. 6, network device 710 of FIG. 7, and computing system 900 of FIG. 9). The network device may be computing device, such as a base station (e.g., a 3GPP gNB for 5G/NR, a 3GPP eNB for LTE, a Wi-Fi AP, or other base station) or a component of a base station, a component of a disaggregated base station (e.g., a central unit, a distributed unit, and/or a radio unit), or other type of computing device. The operations of the process 800 may be implemented as software components that are executed and run on one or more processors (e.g., processor 484 of FIG. 4, processor 910 of FIG. 9, or other processor(s)). Further, the transmission and reception of signals by the network device in the process 800 may be enabled, for example, by one or more antennas (e.g., antennas 234a, 234t of FIG. 2, and antenna 487 of FIG. 4) and/or one or more transceivers (e.g., wireless transceiver(s) 478 of FIG. 4).

At block 802, the network device (or component thereof, such as at least one transceiver) can transmit, to one or more network devices (e.g., including different base stations), a handover message for handing over communication coverage for a vehicle by the first network device to a second network device of the one or more network devices. The handover message includes one or more safety ratings required for the vehicle. For instance, each safety rating of the one or more safety ratings can be a respective or different Automotive Safety Integrity Level (ASIL). In some cases, the handover message further includes one or more parameters (e.g., one parameter or multiple parameters). The one or more parameters can include one or more communication configuration parameters of the vehicle, a required data rate for one or more applications of the vehicle that are related to the one or more safety ratings, a required latency for the one or more applications, a required reliability for the one or more applications, a route of the vehicle (e.g., as indicated by route code, an index, and/or other representation), a destination of the vehicle, any combination thereof, and/or other parameters. In some aspects, the one or more communication configuration parameters of the vehicle can include a quantity of (e.g., a number of) one or more antennas of the vehicle, a brand associated with the one or more antennas, a type of the one or more antennas, a model of the one or more antennas, a respective location of each antenna of the one or more antennas on the vehicle, any combination thereof, and/or other parameters of the vehicle.

At block 804, the network device (or component thereof, such as at least one transceiver) can receive, from at least one of the one or more network devices, at least one response message sent in response to the handover message. In some cases, the at least one response message includes a single response message. In such cases, the single response message can include a confirmation from the second network device to accept a handover of communication coverage for the vehicle.

In some cases, the one or more network devices include a plurality of network devices and the at least one response message includes a plurality of response messages from the plurality of network devices (e.g., one response message from each network device, such as a first response message from the second network device, a second response message from a third network device, etc.). Each response message of the plurality of response messages can include a respective capability (e.g., as capability information) of each network device of the plurality of network devices (e.g., the first response message from the second network device can include a capability of the second network device, the second response message from the third network device can include a capability of the third network device, etc.).

In some cases, a capability of a network device included in a response message (e.g., provided as capability information in the response message) of the plurality of response messages can include whether each of the one or more safety ratings can be achieved by the network device, a highest safety rating from the one or more safety ratings that can be achieved by the network device, a maximum traffic load to achieve the highest safety rating from the one or more safety ratings that can be achieved by the network device, a highest data rate that can be achieved by the vehicle for one or more applications of the vehicle that are related to the one or more safety ratings, a lowest latency that can be achieved by the vehicle for the one or more applications, a reliability that can be achieved by the vehicle for the one or more applications, a maximum distance for the communication coverage for the vehicle that can be achieved, any combination thereof, and/or other capability information of the network device.

In some aspects, the network device (or component thereof, such as at least one processor) can determine one or more qualified network devices of the plurality of network devices for a handover of communication coverage for the vehicle based on a respective capability of each network device of the one or more qualified network devices indicating that each network device of the one or more qualified network devices can satisfy the one or more safety ratings required for the vehicle. For instance, as described above with respect to FIG. 6, the first network device 610 can determine, based on the capabilities of the second network devices 620a, 620b, 620c, one or more “qualified” network devices from the second network devices 620a, 620b, 620c for a handover of communication coverage for the vehicle 630. The first network device 610 can determine a second network device to be a “qualified” network device when the first network device 610 determines, based on the capability of the second network device, that the second network device can satisfy the one or more safety ratings when providing communication coverage to the vehicle 630 (e.g., when the vehicle 630 is located within a coverage area of the second network device, such as along the road 605). In some cases, the first network device 610 can handover communication coverage for the vehicle 630 to the second network device, so that the second network device can provide communication coverage (e.g., by scheduling one or more communications resources) for the vehicle 630.

In some aspects, the one or more qualified network devices includes a plurality of qualified network devices (including the second network device). In such aspects, the network device (or component thereof, such as at least one processor) can determine the second network device from the plurality of qualified network devices for the handover of communication coverage of the vehicle based on at least one of a random selection, the second network device having a best achievable rate among the plurality of qualified network devices for one or more applications of the vehicle that are related to the one or more safety ratings, the second network device having a best achievable latency among the plurality of qualified network devices for the one or more applications, the second network device having a best achievable reliability among the plurality of qualified network devices for the one or more applications, the second network device having a longest distance along a route of the vehicle among the plurality of qualified network devices for the communication coverage for the vehicle that can be achieved, any combination thereof, and/or based on other factors.

In some cases, the network device (or component thereof, such as at least one processor) may determine no qualified network devices of the plurality of network devices for a handover of communication coverage for the vehicle, such as based on a respective capability of each network device of the plurality of network devices indicating that no network devices of the plurality of network devices can satisfy the one or more safety ratings required for the vehicle. In such cases, the network device (or component thereof) can determine, based on a best achievable safety rating for each of the one or more safety ratings of the plurality of network devices, the second network device from the plurality of network devices for a handover of communication coverage for the vehicle. In some examples, the network device (or component thereof, such as at least one transceiver) can transmit, to the vehicle, the best achievable safety rating for each of the one or more safety ratings. In some cases when no qualified network devices are determined, the network device (or component thereof) can split each of one or more tasks amongst more than one network device of the plurality of network devices. For instance, each task of the one or more tasks may include processing one or more communication signals. In some aspects, the network device (or component thereof) can transmit, to the vehicle, a notification message indicating the more than one network device of the plurality of network devices performing the one or more tasks.

In some cases, the at least one response message includes information associated with handing over communication coverage for the vehicle by the second network device to a third network device of the one or more network devices along a route of the vehicle. For instance, as described herein, the first network device can perform a deep base station search (e.g., for the second base station, a third base station, a fourth base station, etc.) to determine, for the handover of communication coverage for the vehicle, qualified base stations that are located further along a route of the vehicle. The deep base station search procedure can allow handovers to be made to multiple network devices (e.g., base stations) located along the route of the vehicle.

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 912 of high-speed memory connected directly with, in close proximity to, or integrated as part of processor 910.

Processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radiofrequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor (s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,”“at least one processor being configured to,” “one or more processors configured to,” “one or more processors being configured to,” or the like indicates that one processor or multiple processors (in any combination) can perform the associated operation (s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A first network device for wireless communication, the first network device comprising: at least one memory; and at least one processor coupled to the at least one memory and configured to: transmit, via at least one transceiver to one or more network devices, a handover message for handing over communication coverage for a vehicle by the first network device to a second network device of the one or more network devices, wherein the handover message comprises one or more safety ratings required for the vehicle; and receive, via the at least one transceiver from at least one of the one or more network devices, at least one response message sent in response to the handover message.

Aspect 2. The first network device of Aspect 1, wherein each of the one or more safety ratings is a respective Automotive Safety Integrity Level (ASIL).

Aspect 3. The first network device of any one of Aspects 1 or 2, wherein the first network device is a first base station and each network device of the one or more network devices is a different base station.

Aspect 4. The first network device of any one of Aspects 1 to 3, wherein the handover message further comprises one or more parameters, the one or more parameters comprising at least one of one or more communication configuration parameters of the vehicle, a required data rate for one or more applications of the vehicle that are related to the one or more safety ratings, a required latency for the one or more applications, a required reliability for the one or more applications, a route of the vehicle, or a destination of the vehicle.

Aspect 5. The first network device of Aspect 4, wherein the one or more communication configuration parameters of the vehicle comprise at least one of a quantity of one or more antennas of the vehicle, a brand associated with the one or more antennas, a type of the one or more antennas, a model of the one or more antennas, or a respective location of each antenna of the one or more antennas on the vehicle.

Aspect 6. The first network device of any one of Aspects 1 to 5, wherein the at least one response message comprises a single response message, the single response message comprising a confirmation from the second network device to accept a handover of communication coverage for the vehicle.

Aspect 7. The first network device of any one of Aspects 1 to 6, wherein the one or more network devices comprise a plurality of network devices and the at least one response message comprises a plurality of response messages from the plurality of network devices, each response message of the plurality of response messages comprising a respective capability of each network device of the plurality of network devices.

Aspect 8. The first network device of Aspect 7, wherein a capability of a network device included in a response message of the plurality of response messages comprises at least one of whether each of the one or more safety ratings can be achieved by the network device, a highest safety rating from the one or more safety ratings that can be achieved by the network device, a maximum traffic load to achieve the highest safety rating from the one or more safety ratings that can be achieved by the network device, a highest data rate that can be achieved by the vehicle for one or more applications of the vehicle that are related to the one or more safety ratings, a lowest latency that can be achieved by the vehicle for the one or more applications, a reliability that can be achieved by the vehicle for the one or more applications, or a maximum distance for the communication coverage for the vehicle that can be achieved.

Aspect 9. The first network device of any one of Aspects 7 or 8, wherein the at least one processor is configured to determine one or more qualified network devices of the plurality of network devices for a handover of communication coverage for the vehicle based on a respective capability of each network device of the one or more qualified network devices indicating that each network device of the one or more qualified network devices can satisfy the one or more safety ratings required for the vehicle.

Aspect 10. The first network device of Aspect 9, wherein the one or more qualified network devices comprises a plurality of qualified network devices, the plurality of qualified network devices comprising the second network device, and wherein the at least one processor is configured to: determine the second network device from the plurality of qualified network devices for the handover of communication coverage for the vehicle based on at least one of a random selection, the second network device having a best achievable rate among the plurality of qualified network devices for one or more applications of the vehicle that are related to the one or more safety ratings, the second network device having a best achievable latency among the plurality of qualified network devices for the one or more applications, the second network device having a best achievable reliability among the plurality of qualified network devices for the one or more applications, or the second network device having a longest distance along a route of the vehicle among the plurality of qualified network devices for the communication coverage for the vehicle that can be achieved.

Aspect 11. The first network device of any one of Aspects 7 or 8, wherein the at least one processor is configured to determine no qualified network devices of the plurality of network devices for a handover of communication coverage for the vehicle based on a respective capability of each network device of the plurality of network devices indicating that no network devices of the plurality of network devices can satisfy the one or more safety ratings required for the vehicle.

Aspect 12. The first network device of Aspect 11, wherein the at least one processor is configured to determine, based on a best achievable safety rating for each of the one or more safety ratings of the plurality of network devices, the second network device from the plurality of network devices for a handover of communication coverage for the vehicle.

Aspect 13. The first network device of Aspect 12, wherein the at least one processor is configured to transmit, via the at least one transceiver to the vehicle, the best achievable safety rating for each of the one or more safety ratings.

Aspect 14. The first network device of any one of Aspects 11 to 13, wherein the at least one processor is configured to split each of one or more tasks amongst more than one network device of the plurality of network devices.

Aspect 15. The first network device of Aspect 14, wherein each task of the one or more tasks comprises processing one or more communication signals.

Aspect 16. The first network device of any one of Aspects 14 or 15, wherein the at least one processor is configured to transmit, via the at least one transceiver to the vehicle, a notification message indicating the more than one network device of the plurality of network devices performing the one or more tasks.

Aspect 17. The first network device of any one of Aspects 1 to 16, wherein the at least one response message comprises information associated with handing over communication coverage for the vehicle by the second network device to a third network device of the one or more network devices along a route of the vehicle.

Aspect 18. A method of wireless communication performed at a first network device, the method comprising: transmitting, to one or more network devices, a handover message for handing over communication coverage for a vehicle by the first network device to a second network device of the one or more network devices, wherein the handover message comprises one or more safety ratings required for the vehicle; and receiving, from at least one of the one or more network devices, at least one response message sent in response to the handover message.

Aspect 19. The method of Aspect 18, wherein each of the one or more safety ratings is a respective Automotive Safety Integrity Level (ASIL).

Aspect 20. The method of any one of Aspects 18 or 19, wherein the first network device is a first base station and each network device of the one or more network devices is a different base station.

Aspect 21. The method of any one of Aspects 18 to 20, wherein the handover message further comprises one or more parameters, the one or more parameters comprising at least one of one or more communication configuration parameters of the vehicle, a required data rate for one or more applications of the vehicle that are related to the one or more safety ratings, a required latency for the one or more applications, a required reliability for the one or more applications, a route of the vehicle, or a destination of the vehicle.

Aspect 22. The method of Aspect 21, wherein the one or more communication configuration parameters of the vehicle comprise at least one of a quantity of one or more antennas of the vehicle, a brand associated with the one or more antennas, a type of the one or more antennas, a model of the one or more antennas, or a respective location of each antenna of the one or more antennas on the vehicle.

Aspect 23. The method of any one of Aspects 18 to 22, wherein the at least one response message comprises a single response message, the single response message comprising a confirmation from the second network device to accept a handover of communication coverage for the vehicle.

Aspect 24. The method of any one of Aspects 18 to 23, wherein the one or more network devices comprise a plurality of network devices and the at least one response message comprises a plurality of response messages from the plurality of network devices, each response message of the plurality of response messages comprising a respective capability of each network device of the plurality of network devices.

Aspect 25. The method of Aspect 24, wherein a capability of a network device included in a response message of the plurality of response messages comprises at least one of whether each of the one or more safety ratings can be achieved by the network device, a highest safety rating from the one or more safety ratings that can be achieved by the network device, a maximum traffic load to achieve the highest safety rating from the one or more safety ratings that can be achieved by the network device, a highest data rate that can be achieved by the vehicle for one or more applications of the vehicle that are related to the one or more safety ratings, a lowest latency that can be achieved by the vehicle for the one or more applications, a reliability that can be achieved by the vehicle for the one or more applications, or a maximum distance for the communication coverage for the vehicle that can be achieved.

Aspect 26. The method of any one of Aspects 24 or 25, further comprising determining one or more qualified network devices of the plurality of network devices for a handover of communication coverage for the vehicle based on a respective capability of each network device of the one or more qualified network devices indicating that each network device of the one or more qualified network devices can satisfy the one or more safety ratings required for the vehicle.

Aspect 27. The method of Aspect 26, wherein the one or more qualified network devices comprises a plurality of qualified network devices, the plurality of qualified network devices comprising the second network device, the method further comprising: determining the second network device from the plurality of qualified network devices for the handover of communication coverage for the vehicle based on at least one of a random selection, the second network device having a best achievable rate among the plurality of qualified network devices for one or more applications of the vehicle that are related to the one or more safety ratings, the second network device having a best achievable latency among the plurality of qualified network devices for the one or more applications, the second network device having a best achievable reliability among the plurality of qualified network devices for the one or more applications, or the second network device having a longest distance along a route of the vehicle among the plurality of qualified network devices for the communication coverage for the vehicle that can be achieved.

Aspect 28. The method of any one of Aspects 24 or 25, further comprising determining no qualified network devices of the plurality of network devices for a handover of communication coverage for the vehicle based on a respective capability of each network device of the plurality of network devices indicating that no network devices of the plurality of network devices can satisfy the one or more safety ratings required for the vehicle.

Aspect 29. The method of Aspect 28, further comprising determining, based on a best achievable safety rating for each of the one or more safety ratings of the plurality of network devices, the second network device from the plurality of network devices for a handover of communication coverage for the vehicle.

Aspect 30. The method of Aspect 29, further comprising transmitting, to the vehicle, the best achievable safety rating for each of the one or more safety ratings.

Aspect 31. The method of any one of Aspects 28 to 30, further comprising splitting each of one or more tasks amongst more than one network device of the plurality of network devices.

Aspect 32. The method of Aspect 31, wherein each task of the one or more tasks comprises processing one or more communication signals.

Aspect 33. The method of any one of Aspects 31 or 32, further comprising transmitting, to the vehicle, a notification message indicating the more than one network device of the plurality of network devices performing the one or more tasks.

Aspect 34. The method of any one of Aspects 18 to 33, wherein the at least one response message comprises information associated with handing over communication coverage for the vehicle by the second network device to a third network device of the one or more network devices along a route of the vehicle.

Aspect 35. A non-transitory computer-readable storage medium comprising instructions stored thereon which, when executed by at least one processor, causes the at least one processor to perform operations according to any one of Aspects 18 to 34.

Aspect 36. An apparatus for wireless communication, comprising one or more means for performing operations according to any one of Aspects 18 to 34.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A first network device for wireless communication, the first network device comprising:
at least one memory; and
at least one processor coupled to the at least one memory and configured to:
transmit, via at least one transceiver to one or more network devices, a handover message for handing over communication coverage for a vehicle by the first network device to a second network device of the one or more network devices, wherein the handover message comprises one or more safety ratings required for the vehicle; and
receive, via the at least one transceiver from at least one of the one or more network devices, at least one response message sent in response to the handover message.

2. The first network device of claim 1, wherein each of the one or more safety ratings is a respective Automotive Safety Integrity Level (ASIL).

3. The first network device of claim 1, wherein the first network device is a first base station and each network device of the one or more network devices is a different base station.

4. The first network device of claim 1, wherein the handover message further comprises one or more parameters, the one or more parameters comprising at least one of one or more communication configuration parameters of the vehicle, a required data rate for one or more applications of the vehicle that are related to the one or more safety ratings, a required latency for the one or more applications, a required reliability for the one or more applications, a route of the vehicle, or a destination of the vehicle.

5. The first network device of claim 4, wherein the one or more communication configuration parameters of the vehicle comprise at least one of a quantity of one or more antennas of the vehicle, a brand associated with the one or more antennas, a type of the one or more antennas, a model of the one or more antennas, or a respective location of each antenna of the one or more antennas on the vehicle.

6. The first network device of claim 1, wherein the at least one response message comprises a single response message, the single response message comprising a confirmation from the second network device to accept a handover of communication coverage for the vehicle.

7. The first network device of claim 1, wherein the one or more network devices comprise a plurality of network devices and the at least one response message comprises a plurality of response messages from the plurality of network devices, each response message of the plurality of response messages comprising a respective capability of each network device of the plurality of network devices.

8. The first network device of claim 7, wherein a capability of a network device included in a response message of the plurality of response messages comprises at least one of whether each of the one or more safety ratings can be achieved by the network device, a highest safety rating from the one or more safety ratings that can be achieved by the network device, a maximum traffic load to achieve the highest safety rating from the one or more safety ratings that can be achieved by the network device, a highest data rate that can be achieved by the vehicle for one or more applications of the vehicle that are related to the one or more safety ratings, a lowest latency that can be achieved by the vehicle for the one or more applications, a reliability that can be achieved by the vehicle for the one or more applications, or a maximum distance for the communication coverage for the vehicle that can be achieved.

9. The first network device of claim 7, wherein the at least one processor is configured to determine one or more qualified network devices of the plurality of network devices for a handover of communication coverage for the vehicle based on a respective capability of each network device of the one or more qualified network devices indicating that each network device of the one or more qualified network devices can satisfy the one or more safety ratings required for the vehicle.

10. The first network device of claim 9, wherein the one or more qualified network devices comprises a plurality of qualified network devices, the plurality of qualified network devices comprising the second network device, and wherein the at least one processor is configured to:
determine the second network device from the plurality of qualified network devices for the handover of communication coverage for the vehicle based on at least one of a random selection, the second network device having a best achievable rate among the plurality of qualified network devices for one or more applications of the vehicle that are related to the one or more safety ratings, the second network device having a best achievable latency among the plurality of qualified network devices for the one or more applications, the second network device having a best achievable reliability among the plurality of qualified network devices for the one or more applications, or the second network device having a longest distance along a route of the vehicle among the plurality of qualified network devices for the communication coverage for the vehicle that can be achieved.

11. The first network device of claim 7, wherein the at least one processor is configured to determine no qualified network devices of the plurality of network devices for a handover of communication coverage for the vehicle based on a respective capability of each network device of the plurality of network devices indicating that no network devices of the plurality of network devices can satisfy the one or more safety ratings required for the vehicle.

12. The first network device of claim 11, wherein the at least one processor is configured to determine, based on a best achievable safety rating for each of the one or more safety ratings of the plurality of network devices, the second network device from the plurality of network devices for a handover of communication coverage for the vehicle.

13. The first network device of claim 12, wherein the at least one processor is configured to transmit, via the at least one transceiver to the vehicle, the best achievable safety rating for each of the one or more safety ratings.

14. The first network device of claim 11, wherein the at least one processor is configured to split each of one or more tasks amongst more than one network device of the plurality of network devices.

15. The first network device of claim 14, wherein each task of the one or more tasks comprises processing one or more communication signals.

16. The first network device of claim 14, wherein the at least one processor is configured to transmit, via the at least one transceiver to the vehicle, a notification message indicating the more than one network device of the plurality of network devices performing the one or more tasks.

17. The first network device of claim 1, wherein the at least one response message comprises information associated with handing over communication coverage for the vehicle by the second network device to a third network device of the one or more network devices along a route of the vehicle.

18. A method of wireless communication performed at a first network device, the method comprising:
transmitting, to one or more network devices, a handover message for handing over communication coverage for a vehicle by the first network device to a second network device of the one or more network devices, wherein the handover message comprises one or more safety ratings required for the vehicle; and
receiving, from at least one of the one or more network devices, at least one response message sent in response to the handover message.

19.-20. (canceled)

21. The method of claim 18, wherein the handover message further comprises one or more parameters, the one or more parameters comprising at least one of one or more communication configuration parameters of the vehicle, a required data rate for one or more applications of the vehicle that are related to the one or more safety ratings, a required latency for the one or more applications, a required reliability for the one or more applications, a route of the vehicle, or a destination of the vehicle.

22.-23. (canceled)

24. The method of claim 18, wherein the one or more network devices comprise a plurality of network devices and the at least one response message comprises a plurality of response messages from the plurality of network devices, each response message of the plurality of response messages comprising a respective capability of each network device of the plurality of network devices, wherein a capability of a network device included in a response message of the plurality of response messages comprises at least one of whether each of the one or more safety ratings can be achieved by the network device, a highest safety rating from the one or more safety ratings that can be achieved by the network device, a maximum traffic load to achieve the highest safety rating from the one or more safety ratings that can be achieved by the network device, a highest data rate that can be achieved by the vehicle for one or more applications of the vehicle that are related to the one or more safety ratings, a lowest latency that can be achieved by the vehicle for the one or more applications, a reliability that can be achieved by the vehicle for the one or more applications, or a maximum distance for the communication coverage for the vehicle that can be achieved.

25.-30. (canceled)
